(19) United States
(12) Patent Application Publication
(10) Pub. No.: US 2006/0026846 A1
(43) Pub. Date: Feb. 9, 2006

(54) Vegetation trimmer apparatus

(76) Inventor: George E. Alliss, Lumberton, NC (US)

Correspondence Address: JOHN F. LETCHFORD, ARCHER & GREINER, P.C., ONE CENENNIAL SQUARE, HADDONFIELD, NJ, 08033, US

(21) Appl. No.: 11/193,093

(22) Filed: Jul. 29, 2005

Related U.S. Application Data
(60) Provisional application No. 60/598,054, filed on Aug. 3, 2004.

(51) Int. Cl. B26B 7/00

(52) U.S. Cl. 30/276

(57) ABSTRACT

A motorized vegetation trimmer apparatus comprising an elongate main handle to which is connected a motor that rotatably drives a trimmer head located at a distal end of the handle. The trimmer head carries one or more radially outwardly projecting cutting members which cut vegetation as the trimmer head rotates. Each cutting member comprises a finite length of flexible strand. The cutting member is releasably gripped in a substantially enclosed chamber by a gripping mechanism including a movable gripping member and a spring that biases the gripping member into gripping contact with the strand. A release member cooperates with the gripping member to urge the gripping member against the biasing force of the spring to permit removal of a cutting member from the trimmer head.

### CROSS REFERENCE TO RELATED APPLICATION

The present application claims the benefit of U.S. Provisional Patent Application No. 60/598,054 filed Aug. 3, 2004, which is incorporated herein by reference in its entirety.

### FIELD OF THE INVENTION

The present invention relates in general to vegetation trimmer apparatus and in particular to vegetation trimmer apparatus having flexible cutting members of finite length.

### BACKGROUND OF THE INVENTION

Internal combustion engine and electric motor powered vegetation trimmers are commonly used to cut and trim grass, weeds, brush and other vegetation. The typical motorized trimmer comprises an elongate handle to which is connected an internal combustion or electric motor that rotatably drives a trimmer head located at a distal end of the handle. The trimmer head, in turn, carries one or more radially outwardly projecting cutting members which cut the vegetation as the trimmer head rotates.

The cutting members may include one more flexible or rigid cutting means. If rigid, the cutting means assume the form of blades fabricated from plastic and/or metal and often have corrugations about their peripheral cutting edges. The blades are pivotally attached to the trimmer head such they yield when they contact hard objects, thereby prolonging the service lives of the blades. Rigid blades are normally used to cut very dense vegetation and may cause considerable injury to the trimmer operator or other persons should they accidentally be struck by the blades during operation of the trimmer.

The cutting means may also be a continuous strand of flexible monofilament plastic line of indefinite length wrapped about a spool contained within the trimmer head. A common type of trimmer head sold as standard equipment on weed trimmer machines is a semi-automatic, spool-type cutting head often referred to as a “bump and feed” or “tap and go” head. In such a device, the plastic line is wound on a storage reel or spool. The line is typically selectively dispensed by the user bumping or tapping the trimmer head on the ground or other hard surface when more line is needed, whereby centrifugal force generated by rotation of the trimmer head pays out additional line. A disadvantage of these sorts of devices is that the line frequently becomes jammed when a user attempts to dispense fresh line from the spool. The jam may be the result of partial fusion of the coils of line or the line becoming entangled. When this occurs, the user must stop the trimming operation, disassemble the trimmer head, fix the jam and reassemble the trimmer head before resuming trimming. Such repeated disruption can be quite frustrating and time-consuming. It is particularly exasperating for professionals in the business of mowing and grooming lawns because of the significant amount of lost time involved.

Other vegetation trimmers have trimmer heads that use finite lengths of fixedly retained plastic line rather than an indefinite length of spooled string as cutting members. These devices, often referred to as “fixed line” trimmers, assume a variety of configurations and methods of operation.

One type of fixed line trimmer employs curvilinear channels or other structure through which the trimmer line is inserted and bent until the trimmer line is firmly gripped by the trimmer head and one or both ends of the trimmer line project from the periphery of the trimmer head. Examples of such devices are provided in U.S. Pat. Nos. 4,190,954; 4,571,831; 4,756,146 and 6,035,618.

In other fixed line trimmers, a portion of the trimmer head must be disassembled and reassembled in order to install a new cutting member or flail when an old cutting member becomes worn or shortened through use. Examples of such devices are provided in U.S. Pat. Nos. 2,663,137; 2,707,859; 3,831,278; 4,043,037; 4,062,115; 4,068,376; 4,089,114; 4,199,926; 4,229,882 and 4,647,242.

In still other fixed line trimmers, the cutting members can be replaced as they become broken or worn without need to resort to disassembly and reassembly of the trimmer head. Examples of such devices are provided in U.S. Pat. Nos. 4,054,992; 4,062,114; 4,118,865; 4,268,964; 4,362,007; 4,513,563; 5,896,666; 6,035,618; 6,347,455; 6,401,344; 6,457,242; 6,519,857 and 6,581,292. Each of these designs suffers from one or more of the following disadvantages: (1) trimmer line with enlarged, knotted or otherwise modified ends must be used to retain the strings in the trimmer head, resulting in additional manufacturing cost and/or installation difficulty, (2) trimmer line of undue length is required for operation, thereby resulting in wasted trimmer line, and (3) trimmer line heads using mechanical trimmer line clamping mechanisms can become clogged with dirt and debris, thereby resulting in failure or seizure of the clamping mechanism.

In addition, trimmer line heads using mechanical trimmer line clamping mechanisms are easy to load but can sometimes be difficult to unload. Frequently, a user may experience difficulty in removing the trimmer line because a clamping member grips the trimmer line so tightly that it becomes fixedly embedded in the trimmer line. In that instance, the trimmer line cannot be removed by many persons by merely grasping the line and pulling it out of the device. The user may need to use pliers or a similar tool to grip the line tightly enough to pull the line free. The trimmer head disclosed in U.S. Pat. No. 6,347,455 provides a release button that could be used to free an embedded clamping member from a trimmer line. However, the trimmer head disclosed in that patent includes several openings in the bottom wall of the trimmer head through which broken trimmer line may be discharged. Each of the openings is in communication with a separate trimmer line clamping mechanism. Consequently, dirt and debris churned up through operation of the trimmer head can enter the holes, clog the clamping mechanisms and render them stiff or even unusable, notwithstanding the presence of the release buttons.

An advantage exists, therefore, for a vegetation trimmer apparatus having a trimmer line head that includes clog-free mechanical trimmer line clamping mechanisms that are easy to load and unload. According to the invention, the mechanical trimmer line clamping mechanisms remain free of debris because of their placement within chambers that do not have any holes that would permit ingress of clogging dirt and debris from the lower surface of the head. Additionally, the clamping mechanisms are operably connected to release means that enable release of gripping members embedded in the trimmer line.

### SUMMARY OF THE INVENTION

The present invention relates to vegetation trimmer apparatus having trimmer heads comprising mechanical trimmer line clamping mechanisms that are reliable and easy to load and unload. The clamping means include clamping members that are biased into a trimmer line gripping position by springs or similar biasing means. The gripping members are operably connected to release means for assisting in the discharge of worn trimmer line from the trimmer head. The clamping means are disposed in a chamber that is effectively closed to the lower surface of the trimmer head housing such that dirt and debris cannot enter the chamber and clog the clamping means. In addition to a reduced likelihood of seizure or failure of the clapming means, the enclosed chamber affords other advantages which are not collectively achievable by presently available vegetation trimmer heads having mechanical trimmer line clamping mechanisms. Namely, the chambers enable relatively short lengths of trimmer line to be used, thereby reducing waste of trimmer line, and enable trimmer line of any cross-sectional configuration to be used in the trimmer head.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 is a perspective view of a motorized vegetation trimmer apparatus including a rotatable trimmer head and a plurality of flexible cutting means;

FIG. 2 is an exploded perspective view of a conventional fixed line trimmer head;

FIG. 3 is an exploded perspective view of a first embodiment of a fixed line trimmer head constructed according to the present invention;

FIG. 4 is a top plan view of the trimmer head bottom body member of FIG. 3 depicting a first embodiment of trimmer line clamping means disposed therein;

FIG. 5 is an exploded perspective view of a further embodiment of a fixed line trimmer head constructed according to the present invention;

FIG. 6 is an assembled perspective view of the trimmer head of FIG. 5;

FIG. 7 is a top plan view of the trimmer head bottom body member of FIG. 5 depicting a further embodiment of trimmer line clamping means disposed therein;

FIG. 8 is an exploded perspective view of a further embodiment of a fixed line trimmer head constructed according to the present invention; and

FIG. 9 is an assembled perspective view of the trimmer head of FIG. 8.

### DETAILED DESCRIPTION OF THE INVENTION

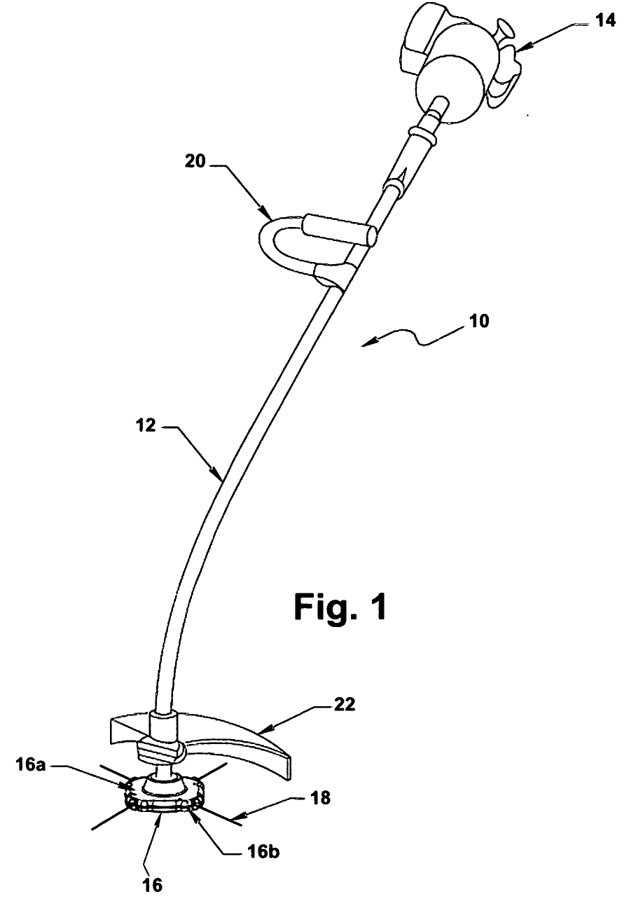

Referring to the drawings wherein like or similar references indicate like or similar elements throughout the several views, there is shown in FIG. 1 a typical motorized vegetation trimmer apparatus 10. Apparatus 10 comprises an elongate main handle 12 which to which is connected an internal combustion or electric motor 14 that rotatably drives a trimmer head 16 located at a distal end of the handle. Trimmer head 16 carries one or more radially outwardly projecting cutting means 18 which cut the vegetation as the trimmer head rotates. Preferably, trimmer apparatus 10 includes a steering handle 20 attached to the main handle 12 to facilitate guidance of the apparatus during operation. A shield 22 is also desirably provided for the operator's safety.

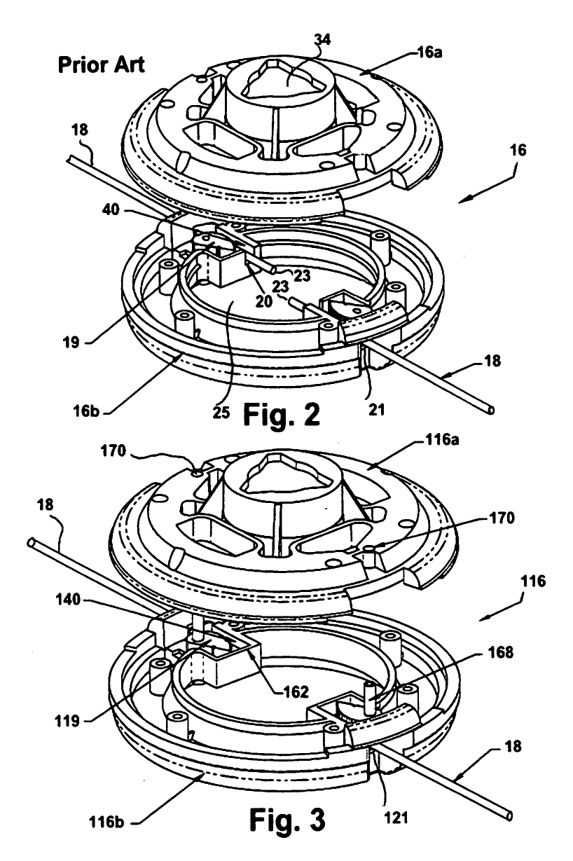

Referring to FIG. 2 there is shown a conventional fixed line trimmer head 16 that is used for cutting vegetation in conjunction with an internal combustion or electric powered trimmer apparatus such as apparatus 10 shown in FIG. 1. Trimmer head 16 comprises a rigid metal or plastic first or “top” body member 16a and a rigid metal or plastic second or “bottom” body member 16b. Upon installation of suitable mechanical trimmer line clamping means, body members 16a, 16b may be permanently fastened to one another. However, to facilitate maintenance or repair of the trimmer head 16, body members 16a, 16b may be releasably connected by cooperating snaps, latches or a number of conventional bolts/screws and cooperating nuts. As used herein, the terms “top” and “bottom” refer to the relative positions that body members 16a, 16b would assume when trimmer head 16 is “in use,” i.e., when attached to the rotating drive shaft of a conventional internal combustion or electric powered trimmer apparatus.

In order to attach trimmer head 16 to the rotating drive shaft of a trimmer apparatus, at least the top body member 16a (or perhaps both body members 16a, 16b) is provided with a central aperture, identified respectively by reference numeral 34 of a diameter sufficient to receive the unillustrated trimmer apparatus drive shaft. The underside of the appropriate one of the first or second body member is preferably configured so as to provide an unillustrated integral central socket for closely receiving a conventional hexagonal or other bolt (also not shown) that is adapted to threadedly mate with the trimmer apparatus drive shaft and releasably attach trimmer head 16 to the drive shaft. The purpose of the socket is to assure that trimmer head 16 is rotatably driven in unison with the drive shaft. The socket prevents slippage of trimmer head 16 with respect to the drive shaft in the event that the cutting members of trimmer head 16 (described below) encounter solid objects or dense or otherwise difficult to cut grass, weeds or other vegetation.

Trimmer head 16 includes at least one passageway 40 for releasably receiving at least one cutting member 18 in the form of a finite length (approximately 4-12″ in length) of flexible monofilament plastic trimmer line, typically nylon strand. Each cutting member 18 may be any constructed as a flexible yet rugged filament, string or wire. Typically, each cutting member is a commercially available flexible monofilament plastic trimmer line of any suitable type and cross-sectional configuration, e.g., 0.065, 0.080, 0.095, 0.105, 0.12, 0.13 or 0.15 gauge nylon trimmer line or the like, which is currently used as cutting filaments in conventional vegetation trimmer apparatus.

Although a minimum of one cutting member 18 and passageway 40 may be used in trimmer head 16, at least two oppositely directed cutting members 18 are commonly deployed in the trimmer head. Furthermore, it will be understood that trimmer head 16 may include three or more usually equiangularly spaced passageways for accommodating a corresponding number of cutting members.

Trimmer head 16 is constructed generally in accordance with the trimmer head described in U.S. Pat. No. 5,896,666, the disclosure of which is incorporated herein in its entirety by reference thereto. Generally, trimmer head 16 includes, for each cutting member 18, a clamping or clamping mechanism comprising a pivoting cam member 19 which is biased into a cutting member clamping position by an unillustrated biasing means such as a torsion spring or the like. In order to position a cutting member 18 in trimmer head 16, a cutting member is inserted into an opening 21 in the periphery of the trimmer head bottom body member 16b and passed along passageway 40 provided therein until the cutting member comes into contact with a clamping face of cam 19. The cutting member 18 is then further inserted by the user such that the free end of the cutting member 18 projects a desired distance from the periphery of the trimmer head 16. As the cutting member 18 passes the cam 19 it rotatably displaces the cam about the cam's pivot axis. The user then releases the cutting member 18 and the cam settles into gripping contact with cutting member 18 under the influence of the biasing spring. The gripping effect on the cutting member is further enhanced by centrifugal force when trimmer head 16 is rotatably driven by the drive shaft of the internal combustion or electric powered apparatus 10.

In order to replace a damaged or worn cutting member 18, the user stops the trimmer apparatus 10, inverts the trimmer head and grasps the inner end 23 of the cutting member 18 located in a central area 25 at the underside of body member 12 and withdraws the cutting member 18 through a discharge opening 27 of passageway 40. A new cutting member 18 then may be inserted in its place as described above.

During operation of trimmer head 16, the high speed rotation of the head and cutting members stirs up dirt and debris, some of which is small enough to enter the discharge openings 27 of passageways 40. Eventually this detritus can accumulate in the cutting member passageways and clamping mechanisms to the point where the clamping mechanisms malfunction due to clogging, thereby rendering it difficult to insert and remove the cutting members from the trimmer head. In addition, the inner end ends 23 of the cutting member must extend nearly to the center of the trimmer head in order to provide sufficient surface area to be grasped by the user's fingers or a gripping tool such as pliers or the like. This portion of the cutting member is useless for cutting purposes and constitutes a considerable waste of material.

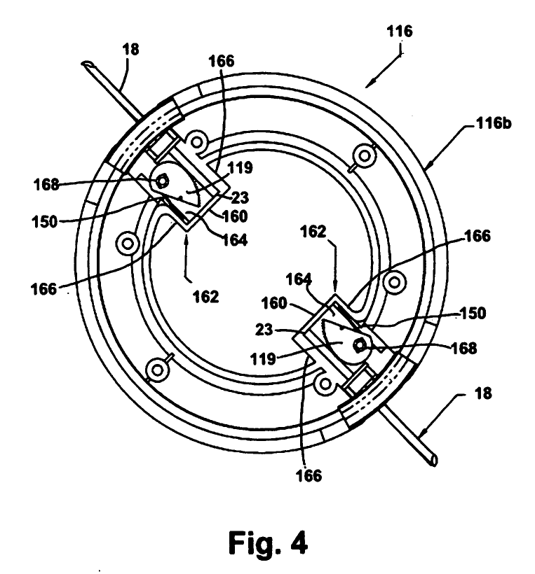

Turning to FIGS. 3 and 4, there is shown a fixed line trimmer head constructed according to the present invention and identified generally by reference numeral 116. Trimmer head 116 is loaded with trimmer line in a manner similar to trimmer head 16 of the prior art. That is, a cutting member 18 is inserted into an opening 121 in the periphery of the trimmer head bottom body member 116b and passed along a passageway 140 provided therein until the cutting member comes into contact with a clamping face of a cam 119 which is biased into a string gripping position by a biasing means 150 such as a torsion spring or the like. As the cutting member 18 passes the cam 119 it rotatably displaces the cam about the cam's pivot axis. The cutting member 18 is then further inserted by the user such that the inner end 23 of the cutting member 18 preferably abuts a rear wall 160 of a substantially enclosed chamber 162. The user then releases the cutting member 18 and the cam settles into gripping contact with cutting member 18 under the influence of the biasing spring. And, as with trimmer head 16, the gripping effect on the cutting member is further enhanced by centrifugal force when trimmer head 116 is rotatably driven by the drive shaft of an internal combustion or electric powered trimmer apparatus.

In addition to rear wall 160, chamber 162 preferably comprises a floor 164 and opposed side walls 166 in contiguous contact with the rear wall which, along with the top body member 116b, substantially enclose the pivoting cam clamping mechanism and passageway 140, thereby keeping the clamping mechanism essentially clog-free and operational at all times. As used herein, a “substantially enclosed” clamping means chamber is one that is effectively closed to the lower surface of the trimmer head housing where dirt and debris are most concentrated and vigorously agitated. While the clamping means chambers of the present invention do have openings, namely, for the cutting member 18 and the various exemplary clamping member release means described below, these openings are located, respectively, on the periphery and upper surface of the trimmer head body. The present inventor has observed that openings in these regions of the trimmer body do not expose the clamping means to detrimental accumulation of dirt and debris.

Because of the enclosed nature of chamber 162, clamping member release means 168 must be provided in order turn the cam 119 against the force of spring 150 to free the cutting member 18 from the cam and enable its withdrawal from trimmer head 116. The clamping member release means 168 is carried by the cam 119 and cooperates with an access aperture 170 (FIG. 3) provided in top body member 116a. Clamping member release means may be structure provided on or in cam 119 and may be recessed, substantially flush with or project outwardly from the upper surface of aperture 170. In the event the clamping member release means is recessed or substantially flush with the upper surface of aperture 170, then such means should be provided with tool-engagement structure whereby it may be engaged by an appropriate tool such as a screwdriver or wrench to enable movement of the cam. If the clamping member release means projects a sufficient distance from the upper surface of aperture 170, then the tool-engagement structure may be omitted if the clamping member release means can be firmly grasped by a user's fingers and moved without significant difficulty. In the instant embodiment, the clamping member release means is in the form of a pin or shaft operably connected to the cam 119 coaxially with the pivot axis thereof. Thus, in order to replace a damaged or worn cutting member 18, the user stops the trimmer apparatus 10, engages the pin or shaft with a tool or grasps it with his or her fingers and rotates the shaft (in a clockwise direction when referring to FIG. 4) to separate the cam from the cutting member 18, and withdraws the cutting member 18 through opening 121 of passageway 140. A new cutting member 18 then may be inserted in its place as described above. It will also be understood that the clamping member release means need not be coaxial with the pivot axis of cam 119; it may be offset therefrom. In that case, aperture 170 would be in the shape of an arc to permit movement of the clamping member release means (and any engagement tool, if necessary) along a corresponding arc-shaped path.

In addition to minimizing exposure of the trimmer line clamping means and passageway to harmful dirt and debris, a trimmer head constructed in accordance with trimmer head 116 and the other trimmer heads described hereinafter can deploy trimmer strings of shorter length than those currently used in conventional fixed line trimmer heads. As noted above, the inner ends of cutting members used in many conventional trimmer heads extend well into the central region of the undersurface of the trimmer head so that they may be grasped and pulled out of the trimmer head when trimmer line replacement becomes necessary. In contrast, the substantially enclosed clamping means chambers of the present invention prevent the inner ends of the cutting members from reaching the central region of the trimmer head. More specifically, the rear wall 160 of chamber 162 (as well as the rear walls of the later described chambers) serves as a stop or abutment for the inner end of a cutting member that limits insertion of the cutting member into the trimmer head. Accordingly, a comparatively shorter trimmer line may be used while still providing a desired length of line projecting from the trimmer head to be used for cutting purposes. The shorter trimmer line, in turn, results in trimmer line manufacturing cost savings which, ultimately, may be passed on to the consumer.

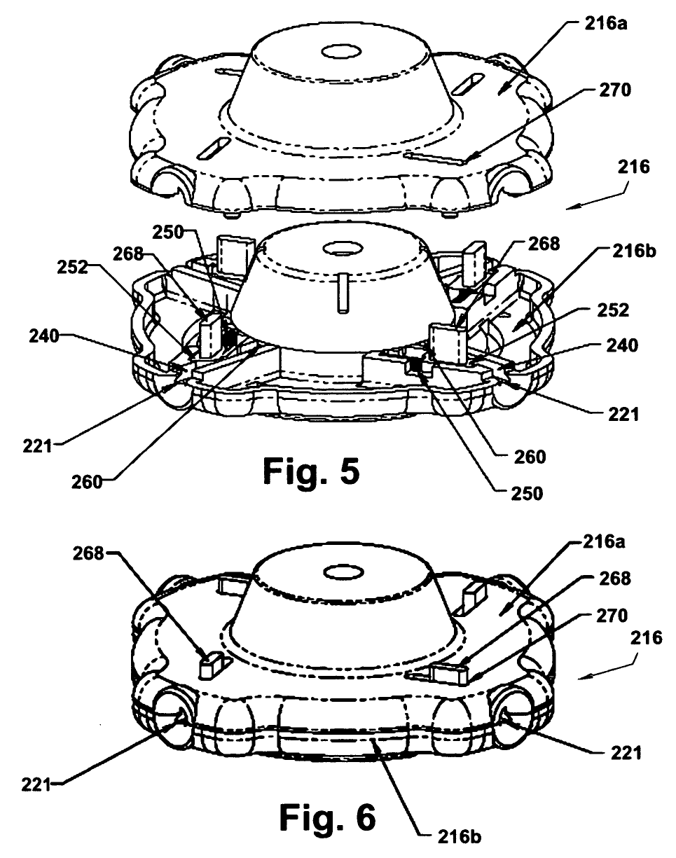

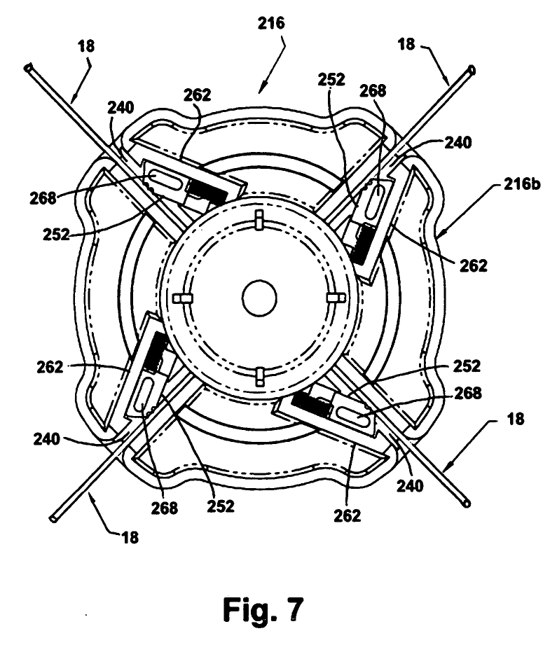

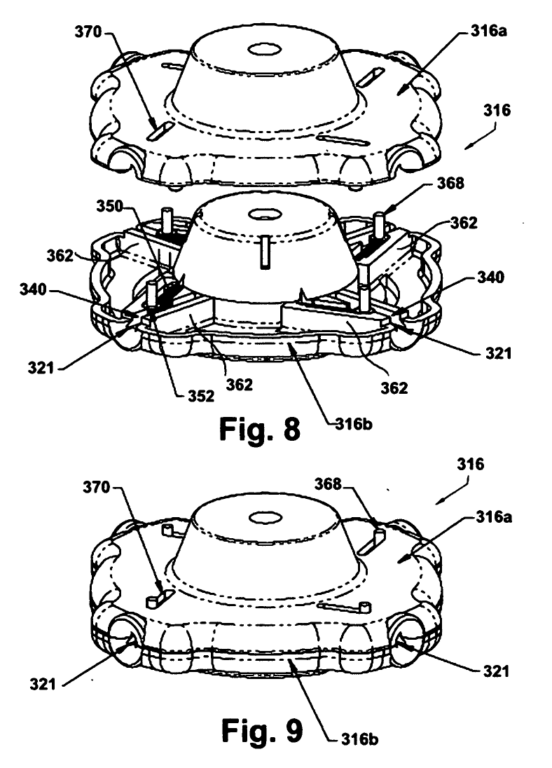

Referring to FIGS. 5-7 there is shown another embodiment of trimmer head constructed according to the present invention and identified generally by reference numeral 216. As seen in FIG. 7, for each cutting member 18, body member 216b is formed with a chamber 262 for receiving clamping means for releasably gripping cutting member 18. Each of the chambers 262 includes an angled component in communication with and disposed at an acute angle with respect to its respective trimmer line passageway 240. Each angled component preferably has a narrow aft portion and an enlarged fore portion. Depending on space considerations associated with a particular trimmer head design, the acute angle of the angled component of chamber 262 may range from about 10° to about 80° with respect to the passageway 240.

As most clearly illustrated in FIG. 7, according to a first presently preferred embodiment, each of the cutting member clamping means includes a compression spring 250 adapted to be received within the aft portion of the angled component of chamber 262 and a reciprocally slidable, generally “D-shaped” rigid cleat member 252 adapted to be received within the fore portion of the angled component of chamber 262. One end of compression spring 250 is seated against a rear wall of the aft portion of the angled component of chamber 262 whereas the opposite end of compression spring 250 is seated against cleat member 252. Compression spring 250 is preferably selected to have a length such that it is at least slightly compressed when seated in the aft portion of the angled component of chamber 262 between the rear wall of the aft portion and cleat member 252, even when no cutting member 18 is present in passageway 240.

Chamber 262, like chamber 162 of FIGS. 3 and 4, is substantially enclosed as defined above and includes a rear wall 260 and unnumbered contiguous floor and side walls. Accordingly, clamping member release means 268 must be provided in order move the cleat member 252 against the force of spring 250 to free the cutting member 18 from the cleat member and enable its withdrawal from trimmer head 216. The clamping member release means 268 is carried by cleat member 252 and cooperates with a slot-shaped access aperture 270 (FIGS. 5 and 6) provided in top body member 216a. Clamping member release means may be structure provided on or in cleat member 252 and may be recessed, substantially flush with or project outwardly from the upper surface of aperture 270. In the event the clamping member release means is recessed or substantially flush with the upper surface of aperture 270, then such means should be provided with tool-engagement structure whereby it may be engaged by an appropriate tool such as a screwdriver or wrench to enable movement of the cleat member. If the clamping member release means projects a sufficient distance from the upper surface of aperture 270, then the tool-engagement structure may be omitted if the clamping member release means can be firmly grasped by a user's fingers and moved without significant difficulty. In the instant embodiment, the clamping member release means structure is in the form of a pin or push lever operably connected to the cleat member 252. Thus, in order to replace a damaged or worn cutting member 18, the user stops the trimmer apparatus 10, engages the clamping member release means with a tool or grasps it with his or her fingers and pushes it against the force of spring 250 to separate the cleat member from the cutting member 18, and withdraws the cutting member 18 through opening 221 of passageway 240. A new cutting member 18 then may be inserted in its place as described above.

This cooperating pin and slot arrangement between the clamping member release means 268 and aperture 270 assures that the cleat member is restrained to smooth, linear reciprocating motion at the aforementioned acute angle and prevents disengagement of the cleat member from spring 250 in the event the cutting member 18 should experience violent impacts arising from contact with solid objects and/or especially dense vegetation.

FIG. 9 represents a further embodiment of trimmer head according to the invention identified generally by reference numeral 316. According to this embodiment, for each cutting member (not shown), body member 316b is formed with a chamber 362 for receiving clamping means for releasably gripping the cutting member. Each of the chambers 262 includes an angled component in communication with and disposed at an acute angle with respect to its respective trimmer line passageway 340. The angled component of chamber 362 preferably has a narrow aft portion and an enlarged fore portion. Depending on space considerations associated with a particular trimmer head design, the acute angle of the angled component of chamber 362 may range from about 10° to about 80° with respect to the passageway 340.

Each of the clamping means preferably includes a compression spring 350 adapted to be received within an aft portion of the angled component of chamber 362 and a reciprocally slidable, generally disk-shaped rigid cleat member 352 adapted to be received within the fore portion of the angled component of chamber 362. Chamber 362, like previously described chambers 162 and 262, is substantially enclosed as defined above with a rear wall and a floor and side walls contiguous with the rear wall. Accordingly, clamping member release means 368 must be provided in order move the cleat member 352 against the force of spring 350 to free a cutting member (not shown) from the cleat member 352 and enable its withdrawal from trimmer head 316. One end of compression spring 350 is seated against a rear wall of the aft portion of the angled component of chamber 362 whereas the opposite end of compression spring 350 is seated against cleat member 352. Compression spring 350 is preferably selected to have a length such that it is at least slightly compressed when seated in the aft portion of the angled component of chamber 362 between the rear wall of aft portion and cleat member 352, even when no cutting member is present in passageway 340.

According to this embodiment, clamping member release means 368 comprises a pin or shaft 368 projecting from the upper face of cleat member 352. Each pin is adapted for cooperating with an elongated slot 370 provided in the top body member 316a. Pin 368 may be recessed, substantially flush with or project outwardly from the upper surface of slot 370 whereby it may be engaged by a tool or a user's fingers, as appropriate, as described above.

The elongated slots 370 are oriented in a direction parallel to the acute angle of the angled component of chamber 362. This cooperating pin and slot arrangement between the trimmer head and cleat member 352 assures that the cleat member is restrained to smooth, linear reciprocating motion at the aforementioned acute angle and prevents disengagement of the cleat member from compression spring 350 in the event a cutting member should experience violent impacts arising from contact with solid objects and/or especially dense vegetation. And, the face of cleat member 352 (and of previously described cam 119 and cleat member 252) that is adapted to contact the cutting member is preferably provided with at least one protrusion means such as one or more ribs or corrugations, knurling or other textured surfacing for enhancing gripping of the cutting member by the clamping means.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A vegetation trimmer head adapted to be rotatably driven by a drive shaft of a motorized vegetation trimmer apparatus, said vegetation trimmer head comprising:
a body having an upper surface, a lower surface and a periphery, said body including means for enabling releasable attachment of said body to a drive shaft of a motorized vegetation trimmer apparatus;
at least one opening in said periphery;
at least one passageway in said body in communication with said at least one opening in said periphery for receiving a vegetation cutting member of finite length;
at least one chamber in said body in communication with said at least one passageway;
clamping means disposed said at least one chamber, said clamping means comprising a movable clamping member and means for biasing said clamping member into engagement with a vegetation cutting member, said at least one chamber being effectively closed to said lower surface and substantially enclosing said clamping means and said passageway; and
release means carried by said clamping member for enabling movement of said clamping member against the biasing force of said biasing means to permit removal of a vegetation cutting member from said at least one opening.

2. The vegetation trimmer head of claim 1 wherein said chamber comprises a rear wall, and a floor and opposed side walls in contiguous contact with said rear wall.

3. The vegetation trimmer head of claim 1 wherein said release means comprise structure projecting from said clamping member.

4. The vegetation trimmer head of claim 3 wherein said upper surface of said trimmer body includes an aperture corresponding to said release means structure for enabling a user to access said release means structure and move said clamping member against the biasing force of said biasing means.

5. The vegetation trimmer head of claim 1 wherein said upper surface of said trimmer body includes an aperture corresponding to said release means structure for enabling a user to access said release means structure and move said clamping member against the biasing force of said biasing means.

6. The vegetation trimmer head of claim 5 wherein said aperture is a slot and said release means structure projects from and is slidably received in said slot.

7. The vegetation trimmer head of claim 1 wherein said clamping member is a pivoting cam.

8. The vegetation trimmer head of claim 1 wherein said clamping member is a reciprocating cleat.

9. A vegetation trimmer apparatus comprising:
an elongate handle;
a motor connected to said handle; and
a rotatable trimmer head connected to said handle and rotatably driven by said motor, said trimmer head comprising:
a body having an upper surface, a lower surface and a periphery, said body including means for enabling releasable attachment of said body to a drive shaft of a motorized vegetation trimmer apparatus;
at least one opening in said periphery;
at least one passageway in said body in communication with said at least one opening in said periphery for receiving a vegetation cutting member of finite length;
at least one chamber in said body in communication with said at least one passageway;
clamping means disposed said at least one chamber, said clamping means comprising a movable clamping member and means for biasing said clamping member into engagement with a vegetation cutting member, said at least one chamber being effectively closed to said lower surface and substantially enclosing said clamping means and said passageway; and
release means carried by said clamping member for enabling movement of said clamping member against the biasing force of said biasing means to permit removal of a vegetation cutting member from said at least one opening.

10. The vegetation trimmer of claim 9 wherein said chamber comprises a rear wall, and a floor and opposed side walls in contiguous contact with said rear wall.

11. The vegetation trimmer of claim 9 wherein said release means comprise structure projecting from said clamping member.

12. The vegetation trimmer of claim 11 wherein said upper surface of said trimmer body includes an aperture corresponding to said release means structure for enabling a user to access said release means structure and move said clamping member against the biasing force of said biasing means.

13. The vegetation trimmer of claim 9 wherein said upper surface of said trimmer body includes an aperture corresponding to said release means structure for enabling a user to access said release means structure and move said clamping member against the biasing force of said biasing means.

14. The vegetation trimmer of claim 13 wherein said aperture is a slot and said release means structure projects from and is slidably received in said slot.

15. The vegetation trimmer of claim 9 wherein said clamping member is a pivoting cam.

16. The vegetation trimmer of claim 9 wherein said clamping member is a reciprocating cleat.
